(19) United States
(12) Patent Application Publication
(10) Pub. No.: US 2021/0142256 A1
(43) Pub. Date: May 13, 2021

(54) User Segment Generation and Summarization

(71) Applicant: Adobe Inc., San Jose, CA (US)

(72) Inventors: Meghanath M Y, Pittsburgh, PA (US); Deepak Pai, Santa Clara, CA (US)

(73) Assignee: Adobe Inc., San Jose, CA (US)

(21) Appl. No.: 16/681,056

(22) Filed: Nov. 12, 2019

(51) Int. Cl. G06Q 10/06; G06Q 30/06

(52) U.S. Cl. CPC G06Q 10/06393; G06Q 30/0631

(57) ABSTRACT

A user segmentation system is described that is configured to generate use segments and summarize user segments. In one example, the user segmentation system is configured to identify which attributes support a key performance indicator. This is used to generate rules that act as user segments of a user population. Further, the user segmentation system is configured to reduce overlap of user segments through summarization.

### BACKGROUND

Service provider systems leverage recommendations in a variety of ways to manage output and dissemination of digital content. Examples include use of recommendations of particular items of interest, companion items, and so on involving digital videos, digital images, digital books, digital marketing content, and other types of digital content. One technique used to do so employs user segments that define attributes of a subset of a user population of user identifiers (IDs). The service provider system then manages which items of digital content are provided to the subsets of the user population based on the user segments. User segmentation may be used to support a variety of other functionality, including personalization.

Conventional user segmentation techniques rely on manual specification of attributes that are used to define the subset of a user population. Thus, conventional techniques rely on domain expertise of data analysts to make a best guess to manually define attributes that control membership of user IDs in a user segment in order to promote a desired outcome. Desired outcomes may include providing a recommendation of an item of digital content of interest, undertaking an associated action, (e.g., subscribing to a digital service), and so on.

In practice, however, hundreds and even thousands of attributes may be used to describe user interaction with digital content. The attributes, for instance, may be used to describe demographics of a user ID associated with the user interaction, features of digital content that is a subject of the interaction, how that interaction occurred, and so forth. Additionally, this user interaction may involve thousands and even millions of user IDs, even over a relatively short timeframe of user interaction.

Consequently, conventional techniques used to manually specify attributes of user segments are inefficient and prone to error. This may be caused by a variety of factors, such as an inability to be made aware of the different attributes, differing desired outcomes, different ways in which success and failure may be measured, and so on which cause needless creation of thousands of different user segments. These thousands of different manually created user segments, for instance, may exhibit significant overlap with each other (e.g., may cover overlapping portions of the user population). This may cause inefficient use of computational resources and budgets used to provide the digital content that is based on the recommendations as well as user fatigue caused by oversaturation of the digital content to user IDs included in the overlapping segments.

### SUMMARY

A user segmentation system is described that overcomes the challenges of conventional manual user segmentation techniques by determining which attributes support a key performance indicator. This is used to generate rules that act as user segments of a user population. Further, the user segmentation system is configured to reduce overlap of user segments, and thereby increases computational and user efficiency in the use of these segments which is not possible in conventional manual techniques that encounter significant overlap.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ user segment generation and summarization techniques described herein.

FIG. 2 depicts a system in an example implementation showing operation of a key performance indicator (KPI) segmentation module of FIG. 1 in greater detail.

FIG. 3 is a flow diagram depicting a procedure in an example implementation in which a user segment is generated by identifying attributes, on which, an outcome of a KPI depends.

FIG. 4 depicts a system in an example implementation showing operation of a rule mining module of FIG. 2 used to generate rules that serve as a basis to define user segments.

FIG. 5 is a flow diagram depicting a procedure in an example implementation in which rules are extracted and labeled to form user segments and metrics defining conciseness and quality.

FIG. 6 depicts an example of rules and metrics including recall, precision, lift, and segment size.

FIG. 7 depicts a system in an example implementation showing operation of the segment summarization module 130 of FIG. 1 in greater detail.

FIG. 8 is a flow diagram depicting a procedure in an example implementation in which user segments are summarized to reduce overlap.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

Overview

Techniques and systems supporting user segment generation and summarization are described. These techniques overcome the challenges of conventional techniques that rely on specialized knowledge and domain expertise to manually create user segments. Further, these techniques support reduction of overlap, e.g., inclusion of a same user ID in multiple user segments. In this way, the techniques described herein may improve efficiency in providing targeted digital content based on the recommendations, improve computational and network efficiency in systems that generate the recommendations and provide the digital content, and improve user efficiency as part of interaction with the digital content including reduced user fatigue.

In an example, a user segmentation system employs a key performance indicator (KPI) segmentation module to generate user segments based on a key performance indicator received as an input from a user. A user interface, for instance, may be output by the KPI segmentation module, via which, an input is received that identifies the KPI, such as revenue, conversion, new subscriptions, computational resource utilization, and so on. This may be provided from a drop-down list, manually input through one or more keywords via a user interface, and so on. The KPI segmentation module also obtains data that identifies which attributes are defined in user interaction data. The attributes describe user interaction of respective user IDs with respective digital content. The attributes, for instance, may describe demographics of a user ID associated with the user interaction, features of digital content that is a subject of the interaction, how that interaction occurred, and so forth.

The KPI segmentation module then determines correlations between the KPI and respective attributes based on the user interaction data. The KPI segmentation module, for instance, may compute a correlation metric such as a Chi Squared Statistic to capture dependency between respective attributes and the KPI. Based on the correlation metric, a p-value may be computed to infer if the attribute is independent of or dependent on the KPI, and as such this quantifies dependency of the KPI on the attribute. A subset of the attributes is then selected by the KPI segmentation module (e.g., based on a ranking of the amount of dependency) to select the “most dependent” attributes and improve computational efficiency of further processing performed by the system.

Based on the subset of selected attributes, the KPI segmentation module performs rule mining to mine for significant patterns (e.g., attributes and corresponding attribute values) from the user interaction data to form rules. The KPI segmentation module, for instance, may perform association rule mining to extract rules based on frequency of occurrence in the user interaction data. A label is then assigned by the KPI segmentation module based on frequency of occurrence attribute value of the KPI. Suppose a KPI is set for a binary purchase event, for instance, that can take values of “purchase” or “no purchase,” exclusively. For a given user segment, if the proportion of user IDs of purchasers is greater than user IDs of non-purchasers, the label “purchase” is assigned. Otherwise, the label “no purchase” is assigned.

The KPI segmentation module then computes metrics for the rule. A metric “lift,” for instance, may be computed with respect to the label. Continuing with the previous example, the lift of the rule assigned to the label of the binary purchase event is given by a ratio of probabilities of the KPI taking the value of the label for the user ID contained in the rule with respect to an entirety of a user population of the user IDs. Thus, intuitively, the higher the lift, the increased importance of the rule to achievement of the KPI.

Other example metrics include recall and precision that measure a quality of segments associated with respective values of the KPI. Precision describes purity, i.e. what fraction of the segment contains user IDs of interest. Recall describes an amount of user IDs of interest that have been included in the segment among all user IDs of interest, and thus maximizing recall minimizes false negatives.

The user segments and associated metrics are then passed from the KPI segmentation module of the user segmentation system to a segment summarization module to summarize overlapping user segments into a subset of segments with minimized overlap. To do so, the segment summarization module first identifies and quantifies metrics of the user segments that are user interpretable, i.e., interpretable by a human.

An objective function is then maximized by the segment summarization module based at least in part on the metrics. The objective function, for instance, may address metrics including a size of the attributes in a respective user segment, a number of the attributes included in the respective user segment, recall, an impurity value indicating a total number of user IDs included in a user segment that are false positives, and a maximum amount of overlap that is permitted between user segments. Other metric examples are also contemplated. By maximizing the objective function in this example, the segment summarization module generates a subset of user segments which has maximum interpretability, both in terms of conciseness and quality metrics, and that acts to summarize the plurality of user segments and reduce overlap.

In this way, the user segmentation system overcomes the challenges of conventional manual user segmentation techniques by determining which attributes support a KPI input by a user, automatically and without user intervention. This is used to generate rules that act as user segments of a user population. Further, the user segmentation system is configured to reduce overlap of user segments, and thereby increases computational and user efficiency in the use of these segments which is not possible in conventional manual techniques that encounter significant overlap. Further discussion of these and other examples is included in the following sections and shown in corresponding figures.

Example Terms

“Recommendations” are used by a service provider system to manage output and dissemination of digital content. Examples include use of recommendations of particular items of interest, companion items, and so on involving digital videos, digital images, digital books, digital marketing content, and other types of digital content.

“Key performance indicators” (KPIs) are an indicator of progress toward an outcome. Examples of KPIs include quantitative and qualitative values, such as new customer acquisition, conversion of a good or service, performance, availability, quality, revenue, number of subscriptions obtained or retained, time of delivery, computational resource consumption, and so forth.

“Attributes” describe user interaction of respective user IDs within user interaction data with respective digital content. “User segments” are defined using attributes. The attributes, for instance, may describe demographics of a user ID associated with the user interaction, features of digital content that is a subject of the interaction, how that interaction occurred, and so on.

A “correlation metric” captures dependency between respective attributes and a KPI. An example of a correlation metric is a Chi Squared Statistic.

“Rule mining” techniques are used to mine for significant patterns (e.g., attributes and corresponding attribute values) from user interaction data to form rules. A “rule” is a combination of an attribute and attribute value and hence can be readily interpreted as a user segment.

A “metric” indicates quality of the rule. Examples of metrics include lift, recall, and precision. Lift quantifies a relative propensity of a certain KPI value in the rule to a propensity of a certain KPI in the whole user population. Precision describes purity, i.e., what fraction of the segment contains user IDs of interest. Recall describes user IDs of interest that have been included in the segment among all user IDs of interest, and thus maximizing recall minimizes false negatives.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

Example Environment

FIG. 1 is an illustration of a digital medium environment 100 in an example implementation that is operable to employ techniques described herein. The illustrated environment 100 includes a service provider system 102, a plurality of client devices, an example of which is illustrated as client device 104, and a digital content management system 106. Computing devices that implement the service provider system 102, the client device 104, and the digital content management system 106 may be configured in a variety of ways.

A computing device, for instance, may be configured as a desktop computer, a laptop computer, a mobile device assuming a handheld configuration such as a tablet or mobile phone, and so forth as illustrated for the client device 104. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as illustrated for the service provider system 102 and the digital content management system 106 and as further described in relation to FIG. 9.

The service provider system 102 includes a digital content targeting system 110 that is useable to control output of digital content 112. The digital content 112 is illustrated as stored in a storage device 114 locally at the system, however this content may be maintained in whole or in part outside of the service provider system 102 (e.g., by the digital content management system 106, the client device 104 and so on). Digital content 112 may take a variety of forms, including digital videos, digital images, digital books, digital marketing content, and other types of digital content.

In order to control output of the digital content 112, the digital content targeting system 110 employs a user segmentation system 118 that is configured to generate a user segment 120, automatically and without user intervention. User segments describe a collection of user IDs of a user population involving interaction with digital content 112. To do so, the user segments 120 are defined using attributes. Attributes may be used to describe demographics of a user ID associated with the user interaction, features of digital content that is a subject of the interaction, how that interaction occurred, and so forth. Therefore, user IDs that have attributes defined as part of a user segment 120 define “membership” within the user segment 120.

The user segment 120 is then passed from the user segmentation system 118 as an input to a digital content recommendation system 122 to generate one or more recommendations 124. The digital content recommendation system 122, for instance, may employ machine learning to train models using training data that describes past user interaction with digital content 112 (e.g., through use of content based and/or collaborative filtering techniques). Once trained, the model is used to generate a recommendation 124 regarding digital content that may be of interest based on user interaction data 116 received from a client device 104. The recommendation 124 is then used to control which items of the digital content 112 are provided back to the client device 104 in this example. The recommendation 124, for instance, may identify a particular digital video to stream, digital images for purchase, digital marketing content to promote conversion of a good or service, and so on. Accordingly, efficient and accurate identification of user segments 120 is an underlying functionality of the service provider system 102 used to control output of digital content 112.

Conventional techniques used to generate user segments, however, are performed manually based on specialized knowledge of a data analyst that may be performed to generate hundreds and even thousands of user segments. This manual generation faces numerous challenges. Firstly, the scale of attributes used to define user segments is nearly unlimited in that a multitude of characteristics may be used to define users (e.g., demographics), digital content that is a subject of the user interaction, and how that user interaction occurs. Additionally, these user segments may overlap in that a user ID may be included in multiple segments. For example, this may result in duplication in generating recommendations 124 and providing digital content 112 and therefore inefficient use of computational and network resources of the service provider system 102 used to generate the recommendation 124 as well as provide the digital content 112, network 108 resources used to communicate the digital content 112, computational resources of the client device 104 used to consume the digital content 112, and so forth. Therefore, tracking thousands of overlapping user segments needlessly consumes significant amounts of computational and network resources of the service provider and can be tedious and time consuming for data analysts to examine.

Accordingly, in the techniques described herein, a key performance indicator (KPI) segmentation module 128 is employed to generate user segments 120 automatically and without user intervention and a segment summarization module 130 which may then be used summarize the generated user segments to remove overlaps. The KPI segmentation module 128, for instance, may receive KPI data 132 via the network 108 as input by a communication module 134 at a digital content management system 106.

The KPI data 132 identifies a particular KPI, which is an indicator of progress toward an outcome. Examples of KPIs include quantitative and qualitative values, such as new customer acquisition, conversion of a good or service, performance, availability, quality, revenue, number of subscriptions obtained or retained, time of delivery, and so forth. The KPI segmentation module 128, upon receipt of the KPI data 132 then locates attributes in user interaction data 116 and determines dependency of the KPI on the attributes. In other words, the KPI segmentation module 128 locates which attributes contribute toward an outcome associated with the KPI and forms the user segment 120 based on these attributes as further described in relation to FIGS. 2-6.

The user segments generated by the KPI segmentation module 128 are then passed to a segment summarization module 130 to summarize the segments as further described in relation to FIGS. 7-8. This is performed by forming a subset of the user segments in order to reduce overlap between segments yet still support the outcome of the KPI (i.e., an outcome of the KPI is dependent on attributes included in the user segment). In this way, the user segmentation system 118 supports an end-to-end framework to automatically generate and summarize user segments of customers as further described in the following sections.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combination and are not limited to the particular combinations represented by the enumerated examples in this description.

User Segment Generation

FIG. 2 depicts a system 200 in an example implementation showing operation of the KPI segmentation module 128 of FIG. 1 in greater detail. FIG. 3 depicts a procedure 300 in an example implementation in which a user segment is generated by identifying attributes, on which, an outcome associated with a KPI depends. FIG. 4 depicts a system 400 in an example implementation showing operation of a rule mining module 214 of FIG. 2 used to generate rules that serve as a basis to define user segments. FIG. 5 depicts a procedure 500 in an example implementation in which rules are extracted and labeled to form user segments and metrics defining conciseness and quality. FIG. 6 depicts an example 600 of rules and metrics including recall, precision, lift, and segment size.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

To begin in this example, KPI data 132 is received by a KPI input module 202. The KPI data 132 identifies a key performance indicator (block 302). A data analyst, for instance, may interact with a communication module 134 (e.g., browser, network-enabled application) to select a KPI from a variety of different KPIs from a menu, manually enter the KPI, and so on. This may also be performed locally, in whole or in part, at the service provider system 102. As previously described KPIs are an indicator of progress toward an outcome. Examples of KPIs include quantitative and qualitative values, such as new customer acquisition, conversion of a good or service, performance, availability, quality, revenue, number of subscriptions obtained or retained, time of delivery, computational resource consumption, and so forth.

An attribute collection module 204 is also employed to collect attributes 206 involving user interaction with digital content from user interaction data 116 (block 304). The user interaction data 116 is illustrated as maintained in a storage device 208 locally at the service provider system 102 but may also be maintained remotely via the network 108, in whole or in part. The attributes 206 describe user interaction of respective user IDs within the user interaction data 116 with respective digital content. The attributes 206, for instance, may describe demographics of a user ID associated with the user interaction, features of digital content 112 that is a subject of the interaction, how that interaction occurred, and so on.

The attributes 206, once generated, are then passed from the attribute collection module 204 to an attribute/KPI correlation module 210. The attribute/KPI correlation module 210 is configured to determine correlations between the key performance indicator identified in the KPI data 132 as being dependent on the attributes 206, respectively, based on the user interaction data 116 (block 306). In other words, this module determines which of the attributes likely contribute to the outcome associated with the KPI. An attribute subset 212 is then formed by the attribute/KPI correlation module 210 based on the determined correlations (block 308).

The attribute/KPI correlation module 210, for instance, may utilize a correlation metric (e.g., a Chi Squared Statistic) to capture dependency between respective attributes 206 and the KPI specified by the KPI data 132. Based on the correlation metric, a p-value may be computed to infer if the attribute is independent of or dependent on the KPI, and as such this quantifies dependency of the KPI on the attribute. An attribute subset 212 is selected by the attribute/KPI correlation module 210 (e.g., based on a ranking of the amount of dependency to select the “most dependent” attributes). Based on the statistic, for instance, the p-value is used to infer if a respective attribute 206 is dependent on or independent of the KPI and attributes are selected to form the attribute subset 212 that are highly dependent on the outcome associated with the KPI (e.g., have a p-value that is less than or equal to 0.01).

The attribute subset 212 is then passed as an input to a rule mining module 214. The rule mining module 214 is configured to generate a rule having a respective attribute and attribute value (block 310) and form the user segment 120 based on the rule (block 312). Using the selected attributes in the attribute subset 212, for instance, the rule mining module 214 performs association rule mining to extract rules that are frequently occurring. As discussed earlier, each rule is a combination of an attribute and attribute value and hence can be readily interpreted as a user segment 120. Therefore, the rule mining module 214 performs rule mining to mine for significant patterns (e.g., attributes and corresponding attribute values) from the user interaction data 116 to form rules based on the attribute subset 212 of dependent attributes 206.

FIG. 4 depicts operation of the rule mining module 214 in greater detail. To begin in the illustrated example, a rule extraction module 402 is employed to extract candidate rules 404 from the attribute subset 212. This extraction is based on frequency of occurrence of respective attributes forming the rule (block 502) in the user interaction data 116. This may be performed by the rule extraction module 402 through ranking the frequency of occurrence and selecting a defined number of “top occurring” rules, based on a threshold amount of frequency, and so forth.

The candidate rules 404 are then passed as an input to a rule labeling module 406 to assign a label to the rules based on frequency of occurrence of an attribute value of the key performance indicator (block 504) and as such generate labelled rules 408. A KPI, for instance, may be set a for a binary purchase event that can take values of “purchase” or “no purchase,” exclusively. For a given candidate rule 404, if the proportion of user IDs of purchasers is greater than user IDs of non-purchasers, the label “purchase” is assigned. Otherwise, the label “no purchase” is assigned.

The labelled rules 408 are then passed from the rule labeling module 406 to a metric generation module 410. The metric generation module 410 is configured to compute at least one metric 412 that indicates quality of the assigned label (block 506). A lift determination module 414, for instance, may be used to compute a “lift” metric with respect to the label. For example, assume a KPI can take k different values represented by {b₁, b₂, . . . , bₖ}, the lift of an arbitrary rule r that is assigned the label b₅, (assuming k>=5) by the rule labeling module 406 is given by the ratio of probabilities of the KPI taking the value b₅ in the customers contained in rule r to the whole customer population.

$${lift}_{: 5} = \frac{P ( KPI = {b}_{5} \vert r )}{P ( KPI = {b}_{5} )} \qquad ( 1 )$$

The lift quantifies the relative propensity of a certain KPI value in the rule (numerator in Eq. 1) to propensity of a certain KPI in the whole user population (denominator in Eq. 1). Hence, intuitively, lift quantifies importance of the rule and corresponding user segment 120 (e.g., to a marketer, data analyst, and so on). For example, user IDs in a respective user segment 120 with higher lift with respect to “purchase” label typically exhibit increased amounts of earned revenue. On the other hand, user segments 120 with higher lift with respect to “no purchase” may specify a useful target for future marketing campaigns.

In another example, a recall determination module 416 and a precision determination module 418 may be used to compute “recall” and “precision,” respectively. Precision describes purity, i.e. what fraction of the segment contains user IDs of interest. Recall describes an amount of user IDs of interest that have been included in the segment among all user IDs of interest, and thus maximizing recall minimizes false negatives. These metrics are defined as follows for a given label b₅ for an arbitrary rule r.

$$\begin{matrix}{recall}_{: 5} = \frac{\# ( KPI = {b}_{5} \vert r )}{\# ( KPI = {b}_{5} )} & ( 2 ) \\ {precision}_{: 5} = \frac{\# ( KPI = {b}_{5} \vert r )}{\# ( KPI = {b}_{5} \vert r ) + \# ( KPI \neq {b}_{5} \vert r )} & ( 3 )\end{matrix}$$

Both these quantities measure the quality of the segments associated with various values of the marketer's selected KPI. For instance, a user segment with a high recall of the value “purchase” with high precision (i.e., low non-purchasers) specifies user IDs corresponding to high revenues.

A representation is then output by the KPI segmentation module 128 of the user segment 120 in a user interface that identifies the respect attribute and the attribute value (block 314), an example user interface 600 is shown in FIG. 6. The user interface 600, for instance, may display user segments 120 for different values of the KPI (e.g., the label) along with metrics that quantify the quality of each segment, such as lift, precision, and recall. The user segments may be displayed in decreasing order of the metrics.

In this way, the techniques described herein overcome the challenges of conventional clustering techniques. Conventional clustering techniques are used to cluster attributes and use the resulting clusters as user segments. There are a variety of challenges associated with this approach. First, clustering techniques such as k-means, hierarchical clustering are not readily interpretable, as in, while supporting a mapping between a user ID and a cluster these techniques do not provide what attributes of the user ID are responsible for the assignment. Second, standard clustering techniques yield sub optimal clusters when the dimensionality of the features is high, which is often the case in digital marketing scenarios. Finally, since the clustering is unsupervised, there is no guarantee that the resulting clusters or segments will contain user IDs having a higher propensity to achieve the KPI.

In the techniques described herein, however, these issues may be addressed in a twofold manner First, attribute selection is performed by the KPI segmentation module 128 to reduce the dimensionality of the attributes and select the attributes that are highly correlated with the KPI. Second, rule mining is employed in the reduced feature space to identify user IDs having a higher propensity associated with the selected KPI. As described above, rule mining is used to find patterns in a given data set in the form of rules. A rule is a combination of an attribute and attribute value (e.g., “Country=US” and “Language=English”).

As described above, in some instances, user segments 120 may exhibit overlaps (e.g., user IDs may be included in multiple segments) which may be inefficient. Accordingly, segment summarization techniques may be employed to reduce this overlap and increase computational and user efficiency as further described in the following section.

User Segment Summarization

FIG. 7 depicts a system 700 in an example implementation showing operation of the segment summarization module 130 of FIG. 1 in greater detail. FIG. 8 depicts a procedure 800 in an example implementation in which user segments are summarized to reduce overlap.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to FIGS. 7-8.

Tracking and analyzing overlapping user segments is a laborious task, which is further complicated by inclusion of overlapping user segments (e.g., the inclusion of user IDs in multiple segments). While there are conventional techniques provided for understanding overlap, conventional techniques do not support a remedy for this overlap.

Accordingly, techniques are described for reducing overlapping user segments through summarization of user segments from a subset of user segments. A segment summarization module 130, for instance, may receive as an input a total of “S” overlapping user segments, covering a total of “N” user IDs and generate a subset of “c, c≤|S|” minimally overlapping user segments while still containing a majority of the “N” user IDs. To achieve this, the segment summarization module 130 first identifies and quantifies attributes of a set of user segments that make the segments user interpretable (e.g., by a human) An optimization technique is then employed to maximize an objective function based on the interpretability measures.

In the illustrated example, the segment summarization module 130 receives user segments 120 and associated metrics 412 from the KPI segmentation module 128. The user segments 120 have respective attributes and attribute values based on user interaction data 116 (block 802).

An interpretability measure identification module 602 is then employed to identify interpretability measures that quantify properties in the plurality of user segments that are user interpretable (block 804). User segments 120 in the form of rules, for example “Country=US” and Language=“English”, are readily interpretable to a human. However, there is a cognitive limit to the amount of information that a human can process in a group of user segments. Accordingly, user segments that are more concise are easier for a human to parse (e.g., for output in the user interface 600) and therefore increase user efficiency. Hence, user segments may be summarized by the segment summarization module 130 by reducing a number of user segments and reducing an amount of attributes that are included in these user segments.

For an arbitrary subset of user segments “R, R⊆S,” these conciseness metrics may be quantified as follows:

$$size ( R ) = \vert R \vert \\ r ∈ R , width ( r ) = \# attributes ( r )$$

Conciseness is complemented by quality of the user segments. Since each user segment is associated with a KPI and takes values {b₁, b₂, . . . , b₄}, the quality of a user segment can be measured by “precision” and “recall” as defined in Equations 2 and 3 above. Precision and recall are used to quantify how well each rule/user segment “r” explains a set of user IDs with an attribute value “bᵢ.” Maximizing “recallᵣᵢ;” is equivalent to minimizing the false negatives “#(KPI=bᵢ|˜r).” Intuitively, a user segment with a higher “precisionᵣᵢ;” and higher “recallᵣᵢ” is qualitatively better.

A subset of the plurality of user segments are generated by an optimization module 604 as summarizing overlapping user segments 606 in the plurality of user segments 120 using an objective function 608 based on the identified interpretability metrics (block 806). The optimization module 604 is configured to search over the user segments 120 for form possible subsets to maximize an objective function 608, which is a linear combination of the interpretability metrics. In the example below, the objective function 608 is written as a combination of five interpretability metrics for an arbitrary group of user segments “R, R⊆S” as follows:

$$0 ( R ) = {\sum }_{i = 1 to 5} {λ}_{i} {y}_{i}$$

1. y₁=|S|−size(R)
2. y₂=Wₘₐₓ−width(R); Wₘₐₓ is the maximum width which is the total number of customer attributes considered.
3. y₃=Σ_{r∈R} recallᵣ
4. y₄=N*|S|−Σ_{r∈R} impurityᵣ; N, the total customers contained in the segments, S is the maximum impurity, that is the false positives that any subset of segments can have.
5. y₅=N*|S|*|S|−Σᵣ_{ᵢ}_{∈R} Σᵣ_{_{j∈}}_{ER} overlap(rᵢ, rⱼ); N is the maximum overlap that any subset of segments can have.
   Intuitively, an optimal solution—the summarization of a set of user segments “S,” is a subset of “S,” which has the maximum interpretability—both in terms of conciseness and quality metrics. “λᵢ” controls the balance between five interpretability measures. Depending on the practical desires, these values may be set accordingly by a user via a user interface. For instance, if a user is ambivalent about a number of rules returned but desires precision in the user segments, “λᵢ” for the size metric may be set to zero, and “λ₄” as corresponding to precision is set higher compared to the other weights “λᵢ.”

The optimization problem addressed by the objective function 608 is therefore:

$$\begin{matrix}max \\ R ⊆ S\end{matrix} 0 ( R )$$

This optimization, over all subsets of “S” maps to a maximum budget coverage problem and is NP Hard. However, the metrics of the objective function (R) namely non-monotonicity and sub modularity contribute to maximization of the objective function with theoretical guarantees. In an implementation, a technique is employed for maximizing a non-monotone, sub modular function, which is known as Smooth Local Search (SLS). SLS is used to selects a subset of the user segments “S” that approximately maximize the objective function (R) 608.

In this way, the user segments 120 are summarized by the segment summarization module 130 as a set of summarized user segments 606. The segment summarization module 130, for instance, receives an input a total of “S” overlapping user segments, covering a total of “N” user IDs and generates a subset of “c, c≤|S|” minimally overlapping user segments while still containing a majority of the “N” user IDs. This improves computational, network, and user efficiency as previously described.

Example System and Device

FIG. 9 illustrates an example system generally at 900 that includes an example computing device 902 that is representative of one or more computing systems and/or devices that may implement the various techniques described herein. This is illustrated through inclusion of the digital content segmentation system 118. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also to allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, a tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution (e.g., the computer-readable storage media described previously).

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware (e.g., through use of computer-readable storage media and/or hardware elements 910 of the processing system 904). The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium user segment generation environment, a method implemented by a computing device, the method comprising:
collecting, by the computing device, attributes of user interaction with digital content from user interaction data based on a key performance indicator;
determining, by the computing device, correlations between the key performance indicator as being dependent on the attributes, respectively, based on the user interaction data;
forming, by the computing device, a subset of the attributes based on the determined correlations;
generating, by the computing device, a plurality of rules by rule mining the subset of the attributes, the plurality of rules having a respective said attribute and attribute value;
forming, by the computing device, a plurality of user segments based on the plurality of rules;
generating, by the computing device, a subset of user segments as summarizing overlapping user segments in the plurality of user segments; and
outputting, by the computing device, a representation of the subset in a user interface that identifies the respective said attribute and the attribute value.

2. The method as described in claim 1, wherein the determining the correlations includes computing a correlation metric that quantifies an amount the key performance indicator is dependent on a respective said attribute.

3. The method as described in claim 1, wherein the generating the rule using rule mining includes:
extracting the rule from the subset of attributes based on frequency of occurrence of respective said attributes forming the rule; and
assigning a label to the rule based on frequency of occurrence of an attribute value of the key performance indicator.

4. The method as described in claim 3, further comprising computing at least one metric that indicates a quality of the assigned label.

5. The method as described in claim 4, wherein the at least one metric is lift, recall, or precision.

6. The method as described in claim 1, wherein the forming of the plurality of user segments includes applying an interpretability measure that addresses conciseness and quality.

7. The method as described in claim 6, wherein:
conciseness is measured by a number of said attributes included in at least one said user segment; and
quality includes:
precision that quantifies how well the at least one said segment explains a set of users with a particular attribute value; or
recall that quantifies a number of false positives.

8. The method as described in claim 1, wherein the generating the subset utilizes an objective function that minimizes overlap between respective said user segments.

9. The method as described in claim 1, wherein the attributes included in the user interaction data include attributes describing user demographics, attributes describing characteristics of the digital content, and attributes describing characteristics of user interaction with the digital content.

10. In a digital medium user segment summarization environment, a segment summarization system comprising:
an interpretability measure identification module implemented at least partially in hardware of a computing device to:
receive a plurality of user segments having respective attributes and attribute values based on user interaction data; and
identify interpretability measures that quantify metrics in the plurality of user segments that are user interpretable; and
an optimization module implemented at least partially in hardware of the computing device to generate a subset of the plurality of user segments as summarizing overlapping user segments in the plurality of user segments using an objective function based on the identified interpretability measures.

11. The segment summarization system as described in claim 10, wherein the interpretability measures include conciseness of respective said user segments.

12. The segment summarization system as described in claim 10, wherein the interpretability measures include quality of the respective said user segments.

13. The segment summarization system as described in claim 12, wherein the quality includes precision indicating a fraction of user identifiers exhibiting the KPI in the respective said user segment.

14. The segment summarization system as described in claim 12, wherein the quality includes recall indicating a fraction of user identifiers included in the respective said user segment with respect to user identifiers of the user population as a whole exhibiting the KPI.

15. The segment summarization system as described in claim 10, wherein the summarizing using the objective function includes maximizing the objective function using a linear combination of the interpretability measures.

16. The segment summarization system as described in claim 10, wherein the interpretability measures include conciseness, precision, and recall.

17. In a digital medium user segment generation environment, a system comprising:
means for receiving key performance indicator data identifying a key performance indicator;
means for collecting attributes of user interaction with digital content from user interaction data;
means for determining correlations between the key performance indicator as being dependent on the attributes, respectively, based on the user interaction data;
means for forming a subset of the attributes based on the determined correlations;
means for generating a rule by rule mining the subset of the attributes, the rule having a respective said attribute and attribute value; and
means for forming a user segment based on the rule.

18. The system as described in claim 17, wherein the determining correlations means includes means for computing a correlation metric that quantifies an amount the key performance indicator is dependent on a respective said attribute.

19. The system as described in claim 17, wherein the forming means includes means for applying an interpretability measure that addresses conciseness and quality.

20. The system as described in claim 19, wherein:
conciseness is measured by a number of said attributes included in the at least one user segment; and
quality includes:
precision that quantifies a fraction of user identifiers exhibiting the DPI in the respective user segment; or
recall that quantifies a fraction of user identifiers in the respective said user segment with respect to user identifiers of the user population as a whole exhibiting the KPI.
